(19) United States
(12) Patent Application Publication
(10) Pub. No.: US 2002/0069236 A1
(43) Pub. Date: Jun. 6, 2002

(54) Methods and systems for providing resources adapted to a user environment

(75) Inventor: Joerg Jahnke, Hamburg (DE)

Correspondence Address: SONNENSCHEIN NATH & ROSENTHAL, P.O. BOX 061080, WACKER DRIVE STATION, CHICAGO, IL, 60606-1080, US

(73) Assignee: Sun Microsystems, Inc.

(21) Appl. No.: 09/982,070

(22) Filed: Oct. 17, 2001

Related U.S. Application Data
(60) Provisional application No. 60/295,784, filed on Jun. 4, 2001.

(30) Foreign Application Priority Data
Oct. 17, 2000 (EP) 00122627.3

(51) Int. Cl. G06F 9/00

(52) U.S. Cl. 709/104

(57) ABSTRACT

Methods, systems, and articles of manufacture consistent with the present invention provide resources adapted to at least one of a number of user environments. Execution of a program is initiated, the program having a session object and a resource identifier that is associated with a number of resource data stored in the session object. While the program is executing, it is determined from the session object which of the number of user environments the program is executing in, and it is identified which of the resource data is suitable for the determined user environment by using both the resource identifier and the determined user environment.

### CROSS-REFERENCE TO RELATED APPLICATIONS

This Application claims the benefit of the filing date of the following U.S. and foreign patent applications, both of which are incorporated herein by reference:

European Patent Application No. 00122627.3, entitled “METHOD AND APPARATUS FOR PROVIDING RESOURCES ADAPTED TO A USER ENVIRONMENT”, filed on Oct. 17, 2000; and

U.S. Provisional Patent Application No. 60/295,784, entitled “METHOD AND APPARATUS FOR PROVIDING RESOURCES ADAPTED TO A USER ENVIRONMENT”, filed on Jun. 4, 2001.

### FIELD OF THE INVENTION

The present invention relates to providing resources to a user, and in particular, the invention relates to providing resource data that is adapted to a user environment.

### BACKGROUND OF THE INVENTION

In communication networks, a user, who is, for example, operating a client data processing device, may access various kinds of information that is stored remotely at a server data processing device, which is located at an arbitrary location. The information can be stored, for example, at a data providing server connected to a network, such as the Internet.

The information that is available for access by the user may comprise, for example, text information, image information, video information, or audio information. The information may be presented to the user by generating a web page at the server data processing device and transmitting display contents to the user for local display. A web page is a piece of information that may be stored at a data server and that may be accessed through a network by a user operating a client data processing device. The user could, for example, specify an address or URL (Uniform Resource Locator) of a particular web page on the network and retrieve the corresponding information. In many cases, web pages are dynamically generated by specific applications upon request by the user. For example, web page applications can be executed at a web server in a process wherein a web page application includes text elements and graphic elements, which are generated into display frames that are transferred to the client for local display.

Communication tools allow a user at a location, provided the user has access to a computer network, to access virtually any kind of information or services throughout the world, including, for example, viewing information for buying a product, retrieving published information, or accessing a user account for setting personal data.

Accordingly, a situation may occur where a large number of users, who are at different locations and who may speak different languages, access the same piece of information that is located somewhere, such as information provided on a web page, and a user may not be familiar with a language the web page is presented in and may not be able to understand the information presented. Further, information can be presented in a format that is specific to a country or region. Users at different locations may expect, for example, date, time or floating point numbers to be presented in a specific format. For example, in the U.S.A., a user may expect a date to be represented as “month/day/year”, while, in Germany, a user may expect a date to be represented as “day.month.year”.

Therefore, information should be presentable in different languages or formats such that potential users may access and understand the information.

As a solution it is conceivable to write, for example, a web page application, in a number of different languages or formats, one version for each language, such that potential users may access and understand the information presented on the web page by selecting to retrieve the web page in a desired language or format.

While this approach may work well in a case where a limited amount of information is to be made available to users, in a case of a large amount of information, such as where a large number of web pages is provided, adapting the contents to different languages or formats may be time consuming and cost prohibitive.

### SUMMARY OF THE INVENTION

Methods, systems, and articles of manufacture consistent with the present invention provide resources, such as resource data, to a user, wherein the resources are adapted the user environment. This allows an application program to present information to different users in different versions at a reduced development cost. Instead of containing, for example, text information to display to a user, the application program contains a resource identifier, which identifies that a piece of information is to be displayed. The resource identifier is independent of the user environment. A resource program calls a lookup function, which loads a lookup object. The lookup object links the resource identifier to a resource data (e.g., the text information), which is dependent upon the user environment. Thus, the application program is independent of the user environment, yet the resource data, which the application program displays, is adapted to the user environment.

For example, assume that a user, who is located in the United States of America, is to view a date on a web page that is administered by a data server, which is located in Germany. A user parameter identifies that the user is located in the United States. Instead of containing the date information in a particular format, the application program contains a resource identifier to identify that date information is to be presented at a particular location on the web page. In order to present the date information to the user in a format that corresponds to a date format used in the United States of America, the resource calls a lookup function, which loads a lookup object. The lookup object links the resource identifier to a resource data, which provides a proper date format for the United States of America. The application program then presents the date to the user in the format that is adapted to the United States of America.

In accordance with methods consistent with the present invention, a method in a data processing system for providing resources adapted to at least one of a plurality of user environments is provided. The method comprises the steps of: initiating execution of a program, the program having a session object and a resource identifier that is associated with a plurality of resource data stored in the session object; and while the program is executing, determining from the session object which of the plurality of user environments the program is executing in; and identifying which of the resource data is suitable for the determined user environment by using both the resource identifier and the determined user environment.

In accordance with methods consistent with the present invention, a method in a data processing system for providing resources adapted to at least one of a plurality of user environments is provided. The method comprises the steps of: initiating execution of a program, the program having a session object and a resource identifier that is, associated with a plurality of resource data stored in the session object; and while the program is executing, determining from the session object which of the plurality of user environments the program is executing in; loading a lookup object for linking the resource identifier with a resource data suitable for the determined user environment; and obtaining the suitable resource data from the lookup object by using the resource identifier and the determined user environment.

In accordance with articles of manufacture consistent with the present invention, a computer-readable medium is provided. The computer-readable medium contains instructions that cause a data processing system to perform a method for providing resources adapted to at least one of a plurality of user environments. The method comprises the steps of: initiating execution of a program, the program having a session object and a resource identifier that is associated with a plurality of resource data stored in the session object; and while the program is executing, determining from the session object which of the plurality of user environments the program is executing in; and identifying which of the resource data is suitable for the determined user environment by using both the resource identifier and the determined user environment.

In accordance with articles of manufacture consistent with the present invention, a computer-readable medium is provided. The computer-readable medium contains instructions that cause a data processing system to perform a method for providing resources adapted to at least one of a plurality of user environments, the method comprising the steps of: initiating execution of a program, the program having a session object and a resource identifier that is associated with a plurality of resource data stored in the session object; and while the program is executing, determining from the session object which of the plurality of user environments the program is executing in; loading a lookup object for linking the resource identifier with a resource data suitable for the determined user environment; and obtaining the suitable resource data from the lookup object by using the resource identifier and the determined user environment.

In accordance with systems consistent with the present invention, a data processing system for providing resources adapted to at least one of a plurality of user environments is provided. The data processing system comprises: a memory comprising a program having a session object and a resource identifier that is associated with a plurality of resource data stored in the session object, the program determining from the session object which of a plurality of user environments the program is executing in, and identifying which of the resource data is suitable for the determined user environment by using both the resource identifier and the determined user environment; and a processing unit that runs the program.

In accordance with systems consistent with the present invention, a data processing system for providing resources adapted to at least one of a plurality of user environments is provided. The data processing system comprises: means for initiating execution of a program, the program having a session object and a resource identifier that is associated with a plurality of resource data stored in the session object; and means for, while the program is executing, determining from the session object which of the plurality of user environments the program is executing in, and identifying which of the resource data is suitable for the determined user environment by using both the resource identifier and the determined user environment.

In accordance with articles of manufacture consistent with the present invention, a computer-readable memory device encoded with a data structure with entries that are accessed by a program which is encoded on the memory device and which is run by a processor in a system is provided. Each entry comprises: a first storage area that stores a resource identifier; and a plurality of second storage areas that each store one of a plurality of resource data corresponding to the resource identifier, each resource data associated with at least one user environment of a session object, wherein the program determines a suitable resource data to be used by using the resource identifier and an indication of a current user environment in which the program is running.

In accordance with methods consistent with the present invention, a method in a data processing system for providing resources adapted to at least one of a plurality of user environments is provided. The method comprises the steps of: initiating execution of a program, the program having an application object and a resource identifier that is associated with a plurality of resource data stored in the application object; and while the program is executing, determining from the application object which of the plurality of user environments the program is executing in; and identifying which of the resource data is suitable for the determined user environment by using both the resource identifier and the determined user environment.

In accordance with methods consistent with the present invention, a method in a data processing system for providing resources adapted to at least one of a plurality of user environments is provided. The method comprises the steps of: initiating execution of a program, the program having an application object and a resource identifier that is associated with a plurality of resource data stored in the application object; and while the program is executing, determining from the application object which of the plurality of user environments the program is executing in; loading a lookup object for linking the resource identifier with a resource data suitable for the determined user environment; and obtaining the suitable resource data from the lookup object by using the resource identifier and the determined user environment.

In accordance with articles of manufacture consistent with the present invention, a computer-readable medium is provided. The computer-readable medium contains instructions that cause a data processing system to perform a method for providing resources adapted to at least one of a plurality of user environments. The method comprises the steps of: initiating execution of a program, the program having an application object and a resource identifier that is associated with a plurality of resource data stored in the application object; and while the program is executing, determining from the application object which of the plurality of user environments the program is executing in; and identifying which of the resource data is suitable for the determined user environment by using both the resource identifier and the determined user environment.

In accordance with articles of manufacture consistent with the present invention, a computer-readable medium is provided. The computer-readable medium contains instructions that cause a data processing system to perform a method for providing resources adapted to at least one of a plurality of user environments, the method comprising the steps of: initiating execution of a program, the program having an application object and a resource identifier that is associated with a plurality of resource data stored in the application object; and while the program is executing, determining from the application object which of the plurality of user environments the program is executing in; loading a lookup object for linking the resource identifier with a resource data suitable for the determined user environment; and obtaining the suitable resource data from the lookup object by using the resource identifier and the determined user environment.

In accordance with systems consistent with the present invention, a data processing system for providing resources adapted to at least one of a plurality of user environments is provided. The data processing system comprises: a memory comprising a program having an application object and a resource identifier that is associated with a plurality of resource data stored in the application object, the program determining from the application object which of a plurality of user environments the program is executing in, and identifying which of the resource data is suitable for the determined user environment by using both the resource identifier and the determined user environment; and a processing unit that runs the program.

In accordance with systems consistent with the present invention, a data processing system for providing resources adapted to at least one of a plurality of user environments is provided. The data processing system comprises: means for initiating execution of a program, the program having an application object and a resource identifier that is associated with a plurality of resource data stored in the application object; and means for, while the program is executing, determining from the application object which of the plurality of user environments the program is executing in, and identifying which of the resource data is suitable for the determined user environment by using both the resource identifier and the determined user environment.

In accordance with articles of manufacture consistent with the present invention, a computer-readable memory device encoded with a data structure with entries that are accessed by a program which is encoded on the memory device and which is run by a processor in a system is provided. Each entry comprises: a first storage area that stores a resource identifier; and a plurality of second storage areas that each store one of a plurality of resource data corresponding to the resource identifier, each resource data associated with at least one user environment of an application object, wherein the program determines a suitable resource data to be used by using the resource identifier and an indication of a current user environment in which the program is running.

The above-mentioned and other features, utilities, and advantages of the invention will become apparent from the following detailed description of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of the specification, illustrate an implementation of the invention and, together with the description, serve to explain the advantages and principles of the invention. In the drawings,

FIG. 1 depicts a block diagram of a data processing system with which embodiments of the present invention may be implemented;

FIG. 2 depicts a block diagram of a data structure with which embodiments of the present invention may be implemented;

FIG. 3 depicts a block diagram of a client-server based data processing system with which embodiments of the present invention may be implemented;

FIG. 4 depicts a flow diagram illustrating the steps of providing resources adapted to a user environment, in accordance with methods, systems, and articles of manufacture consistent with the present invention;

FIG. 5a depicts a flow diagram illustrating the steps of obtaining resource data, in accordance with another embodiment consistent with the present invention;

FIG. 5b depicts a flow diagram illustrating the steps of obtaining resource data, in accordance with another embodiment consistent with the present invention;

FIG. 5c depicts a flow diagram illustrating the steps of obtaining resource data, in accordance with another embodiment consistent with the present invention;

FIG. 6 depicts a data processing system with which embodiments of the present invention may be implemented, and depicting interaction with a client;

FIG. 7a depicts a flow diagram illustrating the steps of providing resources to a client, in accordance with another embodiment consistent with the present invention;

FIG. 7b depicts a flow diagram illustrating the steps of receiving resource data from a client, in accordance with another embodiment consistent with the present invention;

FIG. 8 depicts a time sequence of processing steps for a method for providing resources adapted to a user environment, in accordance with another embodiment consistent with the present invention;

FIG. 9 depicts a time sequence of processing steps for a method for providing resources adapted to a user environment, in accordance with an alternative embodiment consistent with the present invention;

FIG. 10 depicts a time sequence of processing steps a method for providing resources adapted to a user environment, in accordance with an alternative embodiment consistent with the present invention; and

FIG. 11 depicts a time sequence of processing steps a method for providing resources adapted to a user environment, in accordance with an alternative embodiment consistent with the present invention.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

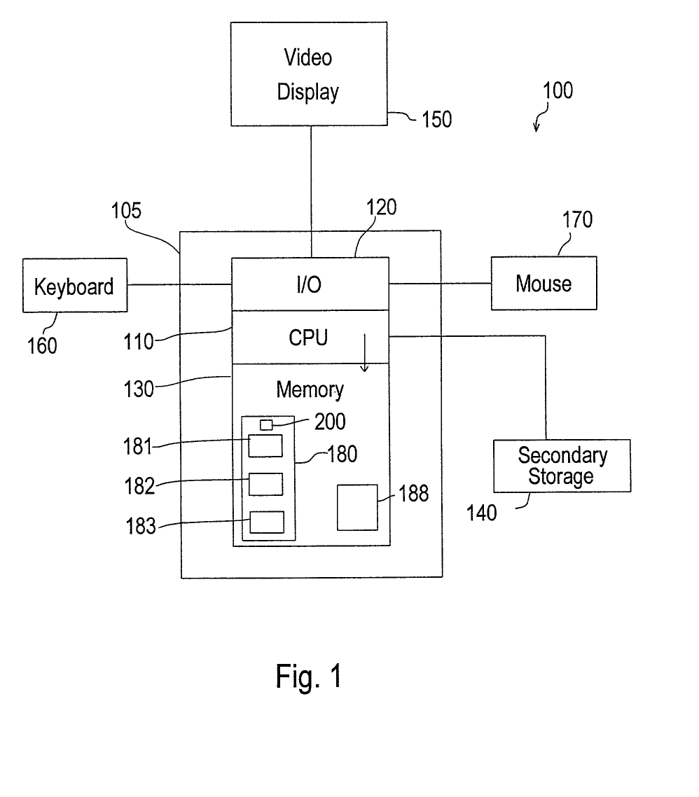

FIG. 1 depicts a block diagram of a data processing system 100 suitable for practicing methods and implementing systems consistent with the present invention. The data processing system 100 comprises a central processing unit (CPU) 110, an input output I/O unit 120, a memory 130, a secondary storage device 140, and a video display 150. The data processing system 100 may further comprise standard input devices such as a keyboard 160, a mouse 170 or a speech processing means (not illustrated).

The memory 130 contains a resource program 180, that includes components for providing resources adapted to a user environment. More specifically, resource program 180 includes components for writing an application that is independent of a user environment and for providing information for presentation to a user that is localized to the user. Resource program 180 components include a user parameter component 181 for setting and storing a user parameter for selecting a user environment, such as a location or a user language preference, based on receipt of a user input. Resource program 180 also includes an application component 182 for executing an application independent of the user parameter, including reading a resource identifier independent of the user parameter, for example, while generating a web page. Resource program 180 also includes a lookup component 183 for loading a lookup object that links the resource identifier and a resource data, wherein the resource data is dependent upon the user parameter (e.g., data presented to the user for display). Lookup component 183 calls a lookup function for obtaining resource data from the lookup object based on the read resource identifier. Resource program 180 and the components 181, 182, and 183 will be described in more detail below. Resource program 180 presents localized information to the user on the video display 150.

A lookup table 188 is located in memory 130. Lookup table 188 contains entries that are looked-up by lookup component 183 in order for the resource program 180 to link the resource identifier, which is independent of the user parameter, and the resource data, which is dependent on the user parameter. In the illustrated implementation, lookup table 188 is stored in memory 130 of the data processing device 100. The lookup table 188 can alternatively be stored in a memory connectable to the data processing device 100, such as a database.

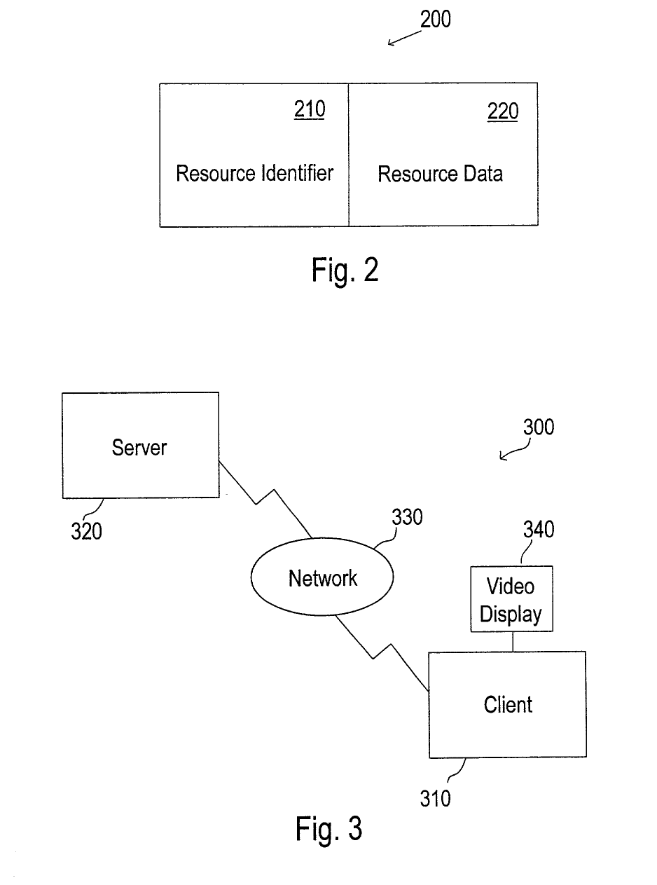

The resource program 180 includes a data structure 200 having entries reflecting lookup object entries of the lookup table 188. FIG. 2 depicts a more detailed diagram of the data structure 200. The sample data structure 200 that is depicted in FIG. 2 illustrates a resource identifier 210 and a corresponding resource data 220.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM. Further, although specific components of data processing system 100 have been described, one skilled in the art will appreciate that a data processing system suitable for use with methods, systems, and articles of manufacture consistent with the present invention may contain additional or different components.

One skilled in the art will appreciate that methods, systems, and articles of manufacture consistent with the present invention may also be implemented in a client-server environment, like the one depicted in FIG. 3. FIG. 3 depicts a block diagram of a client-server based data processing system 300 with which methods, systems, and articles of manufacture consistent with the present invention may be implemented. A client computer system 310 and a server computer system 320 are each connected to a network 330, such as a Local Area Network, Wide Area Network, or the Internet. The resource program 180 can be stored on the client computer system 310 while some or all steps of the processing as described below can be carried out on the server computer system 420, which is accessed by the client computer system 310 over the network 330.

Referring back to FIG. 1, the resource program 180 and the components 181, 182, and 183 need not be implemented as a single program or as separate programs or processes. Rather, the resource program 180 and the components 181, 182, and 183 may be combined into one or more programs or processes, an object-oriented class, or divided functionally in other ways. The illustrated implementation depicts the resource program 180 and the components 181, 182, and 183 as software, but the present implementation may be implemented as a combination of hardware and software or hardware alone.

As will be described in more detail below, resource program 180 provides resources, such as text information, to a user depending on how the user parameter defines the users environment, such as having a selected language or presentation format. An application, for example for providing web pages to a user, may thus be written independently of the user parameter. When the application is executed, the-application component 182 presents information to the user that corresponds to the user parameter. For example, the information is presented in a particular language or format that is understood by the user.

The resource program may receive requests, such as entries of user parameters, from a plurality of users, wherein the users have different nationalities, locations, or languages.

As noted above, the resource program contains the user parameter component 181 that sets at least one user parameter for selecting a user environment for the users. The user parameter may be associated with, for example, a selected language or a user location. For example, the user parameter component 181 may set the user parameter in accordance with a telephone country code used by a user for accessing the resource program. In this example, the user parameter can be set, for example, to “49” for Germany or “01” for the United States of America. Based on the setting of the user parameter, various settings of the user environment can be made. For example, in a case where the user parameter is set to indicate a location of the user in the United States of America, a preferred language of the user may be set to English. Further, information can be displayed in a particular format that corresponds to the United States of America, such as date information can be displayed in a format that corresponds to a format used in the United States of America.

The user parameter component 181 may receive requests from the plurality of users to set a user parameter for each user. This may be accomplished either by the user parameter component 181 requesting a user to select a user parameter or by the user parameter component 181 receiving a selected user parameter from a user. When the user parameter component 181 receives a user parameter from a user, the user parameter can be communicated via, for example, a URL associated with the user parameter component 181. A user parameter for a particular user may be set once upon starting a communication session between the resource program and the user or may be set each time the user transmits a request to the resource program.

As an example, the user parameter component 181 could request the user to select one of a plurality of presented languages for setting the user parameter. For example, the user parameter component 181 could present, on the video display 150, a list of available languages, such as, English, German, Spanish, French and Italian and could request the user to select one of these languages as the preferred language. Also, the user parameter component 181 could present a list of available countries or regions, such as, Germany, Spain, or North America, and could request the user to select one of these countries or regions as the location of the user. Based on input received from the user, the user parameter component 181 would set one or more user parameters.

The resource program may store the user parameters in association with user identifiers, for example as an object, in the memory 130, where they are accessible by the user parameter component 181. Further, the resource program may store the user parameters in a session object or application object. A session object is an object that persists for the duration of a user-session with an application. Information, such as the user parameters, that is stored in a session object is available for the duration of a user-session. An application object is an object that persists for the duration of the execution of an application. Information, such as the user parameter, that is stored in an application object can be shared among all users of the application.

Each user identifier is associated with a user. Thus, the user parameter component 181 can store a list of user identifiers along with user parameters that set, for example, a language corresponding to each user identifier. In a case where no language is selected or the selected language is not available, the user parameter component 181 could set the respective user parameter to a default language. In a case where a request for an execution of an application is received at the resource program from a particular user, the resource program, in a lookup operation, determines the preferred language for that user and resources may be provided to the user in the selected language. The lookup operation will be described in more detail below.

The resource program further includes application component 182 for executing an application program independent of a user environment, that is independent of a user parameter. For example, the application component 182 can execute an application program for generating a web page to be displayed on the video display 150 for the user. The generating of the web page could involve generating frames for display, including graphic elements and text elements. The application component 182 can also independently execute application programs for a plurality of users, in which case, each user could control the execution of a respective application program via user requests received by the application component 182.

The application programs, which are executed by the application component 182, are executed independently of selected user parameters. For example, an application program that is controlled by a user may, instead of containing a text element in a particular language, contain a resource identifier identifying a piece of information to be included at a particular location, for example, on a web page for display to the user. The resource identifier can be, for example, a string. The resource identifier is independent of the user and may be translated by the application component 182 into a particular language or format to be understood by the user in accordance with a selected user parameter. Thus, the application component 182 reads a resource identifier independently of a user parameter and initializes conversion of the resource identifier into resource data in accordance with the selected user parameter for presentation to the user.

The conversion of the resource identifier into resource data for presentation to the user is performed by the lookup component 183. The lookup component 183 calls a lookup function for obtaining resource data from a lookup object based on the read resource identifier. The lookup object links a plurality of resource identifiers and resource data in dependence on a selected user parameter.

Before the lookup component 183 accesses the lookup object for retrieving resource data based on a resource identifier and a user parameter, the lookup component 183 initializes the lookup object. The initialization of the lookup object can include, for example, reading a text file that contains the lookup object data and inserting the data into the lookup object. The initialization of the lookup object may be executed once upon establishing an application program session with a particular user or it may be initialized with each user request.

A plurality of lookup objects may be available, and may be loaded, for example, in dependence on requirements of an application program.

The lookup component 183 may receive, from the application component 182, a read resource identifier that identifies a resource to be presented to a user by the application, and may call a lookup function for obtaining from the lookup object resource data based on the received resource identifier.

The resource data to be presented to the user may comprise, for example, a text element of at least one character, such as a word in a particular language in accordance with the selected user parameter. For example, the resource identifier could identify a resource text element “intellectual property” and, based on a user parameter that identifies the location of the user, the resource data presented to the user could be “Gewerblicher Rechtschutz” for a user in Germany, “Propriete Intellectuelle” for a user in France, or “Intellectual Property” for a user in the United States. Alternatively, the resource data may also be based on a user parameter that sets a language preference of the user.

Further, the resource data may include a resource function that includes rules for character representation, such as for facilitating presentation to a user of a date, a time, a currency or a floating point number.

For example, in a case where the current date is to be presented to a user, the application means 182 can call a resource function for obtaining the current date. Then, the application means 182 can use a resource function for converting the current date into a date format that is based on a user parameter that has been selected by the user. As an illustrative example, the current date “23^{rd} of August, 2000” could be converted to “08/23/00” based on a user parameter that identifies the user's location as in the United States or based on another user parameter that has been selected by the user. In another example, based on a user parameter that identifies the user's location as in Germany, the current date could be converted to “23.08.00” using the resource function in dependence on the selected user parameter.

In a case where the resource data comprises a floating point number, a similar sequence of steps could be carried out. For example, when the application component 182 is to present the number “1.1” in a U.S. format, e.g. for a user in the United States having made an appropriate user parameter selection, the floating point number is presented to the user in the form of “1.1”. For a user, for example in Germany, the application component 182 presents the floating point number to the user in the form “1,1”. Similar conversions of resource identifiers into resource data could be performed in other cases, such as for presentation of currencies.

Accordingly, the above-described resource program 180 includes components for writing an application that is independent of a user environment (i.e., of a selected user parameter) and for providing information for presentation to a user that is localized to the user. The application component 182 executes an application which is independent of a user environment and the lookup component 183 calls a lookup function for inserting localized resource data, for example into a frame containing information to be presented to the user.

Furthermore, data that is locally inputted by a user in a particular format, such as a date or and time format, can be converted into a format independent of a user parameter by using resource functions. For example, a user, who is located in Germany and who's location is identified as Germany based on a user parameter selection, inputs the floating point number “1,1”. The application component 182 can convert the floating point number, using an appropriate resource function, into an internal format that is independent of the user parameter. That is, the application component 182 can convert the floating point number into the format “1.1”.

A user can also select multiple user parameters. For example, a user can select a user parameter specifying language or format, as described above, and a user parameter specifying user other settings, such as characteristics of the display of a device operated by the user, such as a personal data assistant (PDA), a palm top computer, or mobile phone. A user parameter may also specify a user preference for the presentation of web pages, such as to generate customized web pages. For example, a user may wish to view the current time and date at a particular position on the video display of the data processing device or may wish a specific representation of a web page, such as to fit the information into a small screen of a mobile device.

To simultaneously support user parameters that specify languages, formats, and user settings, the resource program can include a plurality of lookup objects.

In brief, the described embodiment provides internationalization capability to applications that are written to be independent of a language or format desired by a particular user. Functions are provided that support localized text resources, that convert locally different user inputs such as date, time, and floating point representation into resource identifiers intended to store such data, that convert resource identifiers such as a current date using resource functions into a localized format.

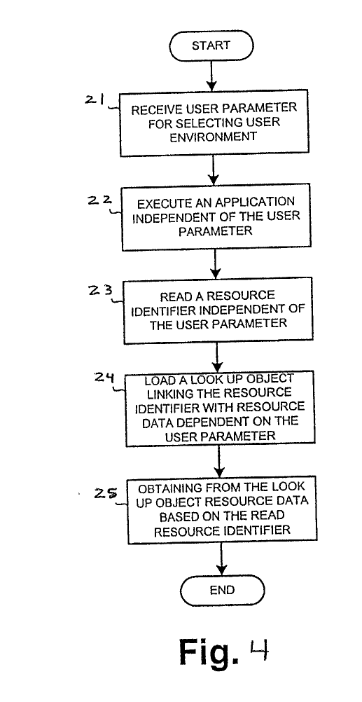

Turning next to FIG. 4, that figure shows a flow chart of a process for providing resources adapted to a user environment consistent with methods, systems, and articles of manufacture consistent with the present invention, and highlights the steps performed by the resource program. The steps described below may be executed using the resource program on the data processing system 100, however, the process shown in FIG. 4 is not limited thereto.

The process depicted in FIG. 4 provides internationalization support to applications that are written to be independent of a language or format desired by a particular user. Functions are provided that support provision of localized text resources, that convert locally different user inputs, such as a current date, into internal formats, and that convert internal formats into localized formats.

In step 21, the resource program sets a user parameter for selecting a user environment. The user parameter may be received from a user and may be stored, for example, in memory 130 as an object, such as a session object or application object, by the user parameter component 181, as described above with reference to FIG. 1. The user parameter may correspond to a user environment including a user location or a user language preference.

In step 22, an application that is independent of the selected user parameter is executed, for example, by the application component 182, as described above with reference to FIG. 1. The application may be controlled by the user, for example, for preparing frames for display on the video display 150 at the user's location. The frames can include, for example, graphic elements and text elements.

In step 23, the application component 182 reads a resource identifier from the application and that is independent of the user parameter. For example, the application executed by the application component 182 may be a program in the form of Microsoft® Active Server® Pages (ASP) for presenting information to a user.

In step 24, the lookup component 183 loads a lookup object from the lookup table 188 for linking the resource identifier, which is independent of the user parameter, such as an identifier in an internal format, and resource data, which is dependent on the user parameter. The lookup object can be loaded from a session object or application object. The resource program may execute step 24 once upon entering a session with a user or may execute step 24 when a request is received from a user or when a user parameter is set by the user. The resource data may comprise a string of at least one character, such as an expression in a particular language. Further, the resource data may correspond to a resource function that includes rules for character representation, such as for date representation, time representation, currency representation, or floating point representation, as described above with respect to FIG. 1.

In step 25, the lookup component 183 calls a lookup function for obtaining resource data from the lookup object based on the read resource identifier. The obtained resource data may be presented to the user. For example, the resource data could represent an expression that is presented to the user in a language that is understood by the user, based on the selected user parameter. Alternatively, the resource data could represent a date or floating point number that is presented to the user in a format that is based on the user parameter. A plurality of lookup operations could be executed, when an application includes a plurality of resource identifiers.

The functions for initializing and loading the lookup object, as well as the functions for performing each of the steps of the process depicted in FIG. 4, can be written in a scripting language, such as the Visual Basic® scripting language.

Further, one of skill in the art will appreciate that the steps outlined in FIG. 4 do not necessarily have to be performed in the depicted order. Instead the order of the steps may be varied as appropriate. For example, step 24 may be executed at any appropriate point in time during execution or may be executed once at the beginning of a session.

Therefore, after the resource program sets the user parameter, the lookup component 183 can load the lookup object, including text resources and resource functions required for the application. The lookup object that is loaded for the application can include specific expressions or signs that are presented in connection with a particular application in different languages or formats, based on the user parameter. It is also possible that a single dictionary, such as a lookup object, is used for all applications containing all resource data which need to be presented to a user.

After the resource program stores the dictionary, for example in a session object, e.g. identified by an object identifier or language identifier, the application, e.g. written in the form of the Microsoft® Active Server® Pages format can use a function which takes a resource identifier as a parameter and returns the resource text, i.e. the lookup function.

The lookup component 183 may further execute a lookup function to determine whether a dictionary exists for the selected user parameter and may retrieve a resource data or resource function from the lookup object. In case a resource identifier does not exist, the lookup component 183 can present an error message to the user that indicates that the resource identifier was not found.

Further, in a case where a resource function is used, user specific input, such as date, time, or floating point numbers, may be converted from a locally dependent format into a locally independent object. For example, the user specific input may be converted into a Visual Basic® Script object. This object that is independent of the selected user parameter may then be used for processing by the application. A result of the processing can then be presented to a user as resource data that is in a format or form corresponding to the user, that is, dependent on the user parameter.

When a number of N users is accessing the resource program, a lookup object, such as resource data and resource functions, may be stored for each user, for example, in a session object or application object. In this case, the resource data are stored N times, one time for each user in a particular language or format. Also, in this case, after a user exits the system, the lookup object may be erased. Further, the resource program can load a set of lookup objects for each user.

Further, for N users that are associated with M languages, the resource program can store one lookup object for all N users. In this case, the resource program stores resource data M times, i.e., in the languages/formats chosen by the users. Further, the resource program can load a set of lookup objects for the plurality of users. In a case where a large number of users accesses the resource program, i.e. in a case where N>M, this alternative efficiently uses available storage space.

Thus, the process depicted in FIG. 4 provides internationalization support to applications which are written to be independent of a language or format desired by a particular user. Functions are provided that support provision of localized text resources, that convert locally different user input like date, time, and floating point representations into resource identifiers that are intended to store such data, and that convert resource identifiers, such as a current date, using resource functions into a localized format.

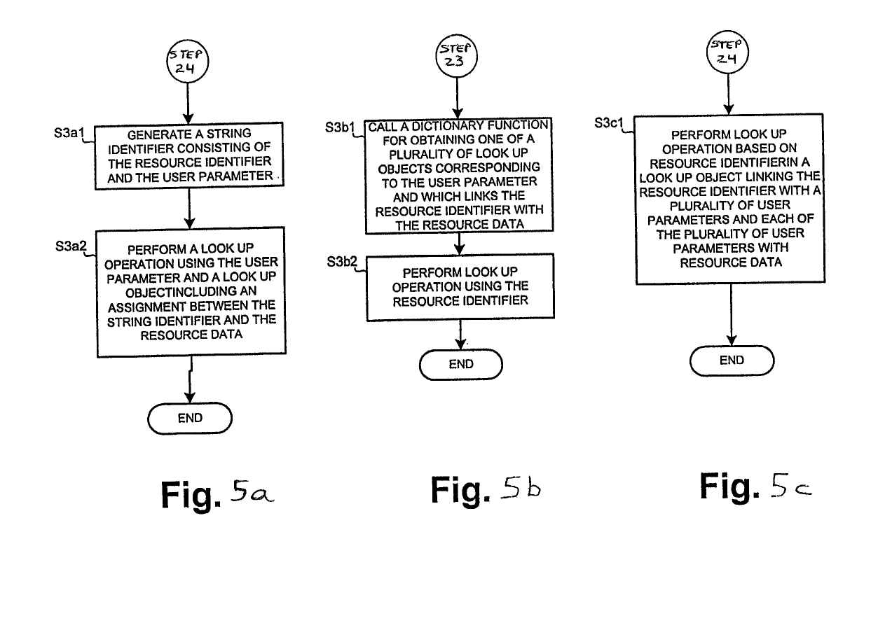

Turning to FIG. 5a, that figure illustrates a flow chart of a process performed by the resource program in accordance with another embodiment consistent with methods, systems, and articles of manufacture consistent with the present invention. The illustrated process outlines the steps for performing the lookup operation for retrieving resource data based on a resource identifier for one or a plurality of users.

The process illustrated in FIG. 5a may be performed using the data processing system 100 depicted in FIG. 1, however, the process of FIG. 3a is not limited thereto.

Since the steps for setting a user parameter (step 21), executing an application (step 22), reading a resource identifier (step 23), and loading a lookup object (step 24) are similar to the steps described with reference to FIG. 4, description starts at an entry point S24, that is, after step 24 described with reference to FIG. 4.

Referring to FIG. 5a, in step S3a1, the lookup component 183 generates a string identifier. The string identifier consists of the read resource identifier and the user parameter. The lookup component 183 may generate the string identifier in a calculation operation that combines the resource identifier and the user parameter.

In step S3a2, the lookup component 183 then performs a lookup operation using the user parameter and the loaded lookup object. In this case, the lookup object includes an assignment between the string identifier and the resource data depending on the resource identifier. Accordingly, the lookup component 183 first converts the resource identifier into the string identifier using the user parameter, and then retrieves the corresponding resource data, for example, from the lookup table 188.

The resource program can then provide the read resource data that depends on the user parameter to the user.

As an example, it is assumed that a resource identifier resID_IP, which is associated with the expression “Intellectual Property”, is read by the application. Further, it is assumed that there is a user parameter “49”, which identifies the user's environment as “Germany”, and a user parameter “01”, which identifies the user's environment as “United States”.

Accordingly, when the user parameter component 181 receives an input from a user to set the user parameter “49”, the lookup component 183 generates a string identifier that consists of the resource identifier resID_IP and the user parameter “49”. The generated string identifier may read as resID_IP_{—}49. This string identifier is preferably stored by the lookup component 181 in the lookup object in association with the German expression “Gewerblicher Rechtschutz”. When the lookup function for obtaining from this lookup object is called, based on the user parameter “49” and the resource identifier resID_IP, the lookup component 183 retrieves the resource data “Gewerblicher Rechtschutz” for presentation to the user.

When the user parameter component 181 receives an input from a user to set the user parameter “01”, the lookup component 183 correspondingly generates a string identifier consisting of the resource identifier resID_IP and the user parameter “01”. The generated string identifier may read as resID_IP_{—}01. Similar to the German version, this string identifier is preferably stored by the lookup component 181 in the lookup object in association with the English expression “Intellectual Property”. When the lookup function for obtaining from this lookup object is called, based on the user parameter “01” and the resource identifier resID_IP, the lookup component 183 retrieves the resource data “Intellectual Property” for presentation to the user.

Accordingly, in the above-described illustrative example, the lookup object may contain the information shown in Table 1.

TABLE I

| | |
|---|---|
| resID_IP_49 | “Gewerblicher Rechtschutz” |
| resID_IP_01 | “Intellectual Property” |

In another example, the resource program presents a floating point number to the user, based on a resource function.

In this illustrative example, it is assumed that a floating point number 1fpt7 is to be presented to a user, wherein fpt stands for floating point. The number to be presented to the user is “1.7”. Further, it is again assumed that the user parameter “49” stands for the user environment “Germany” and the user parameter “01” stands for the user environment “United States”.

When the user parameter component 181 receives an input from a user to set the user parameter “49”, the lookup component 183 generates a string identifier that consists of the resource identifier fpt and the user parameter “49”. The generated string identifier may read as fpt_{—}49. The lookup object thus preferably maintains a rule for placing a “,” in a floating point number in association with the string identifier fpt_{—}49. Accordingly, after the lookup component 183 retrieves the rule stored in association with the string identifier fpt49, the application component 182 presents the number 1fpt7 the user. Based on the selected user parameter “49”, the presented number will be “1,7”.

Similarly, when the user parameter component 181 receives an input from a user to set the user parameter “01”, the lookup component 183 generates a string identifier that consists of the resource identifier fpt and the user parameter “01”. The generated string identifier may read as fpt_{—}01. The lookup object thus preferably maintains a rule for placing a “.” in a floating point number in association with the string identifier fpt_{—}01. Accordingly, after the lookup component 183 retrieves the rule stored in association with the string identifier fpt_{—}01, the application component 182 presents the number 1fpt7 the user. Based on the selected user parameter “01”, the presented number will be “1.7”.

The following contents shown in Table 2 may be stored in the lookup object in connection with the currently-described example.

TABLE 2

| | |
|---|---|
| fpt_49 | rule for floating point “,” |
| fpt_01 | rule for floating point “.” |

The above-described example for floating point representation may also be taken in the other direction, that is, receiving a user input and converting the user input into an internal representation for handling by the application, with the internal representation being independent of the user parameter. In this case, the lookup component 183 can use the same resource function to convert the German version representation of “1,7” into 1fpt7 and the U.S. version “1.7” into the internal version 1fpt7.

The lookup component 183 can perform similar operations to present a date or current time to a user, who selected a specific user parameter. First, when the resource program receives an instruction to present the current date to a user, the resource program can call a function for obtaining the date in an internal format that is independent of the user parameter and can then proceed to convert the internal representation of the local date using the selected user parameter into a corresponding localized representation of the date using a resource function performing a corresponding conversion.

The embodiment consistent with present invention that is described with reference to FIG. 5a allows the resource program to efficiently present a user with localized information by converting a user parameter independent resource identifier into a string identifier comprising the resource identifier and the user parameter and performing a lookup operation in a lookup object using the string identifier for retrieving localized resource data.

Referring to FIG. 5b, that figure illustrates a flow chart of a process performed by the resource program in accordance with another embodiment consistent with methods, systems, and articles of manufacture consistent with the present invention. Similar to the embodiment described with reference to FIG. 5a, the embodiment depicted in FIG. 5b illustrates steps performed by the resource program for retrieving resource data for presentation to one or a plurality of users.

FIG. 5b illustrates an example wherein the lookup component 183 retrieves one of a plurality of lookup objects that correspond to selected user parameters. Thus, for each user parameter a lookup object is available that stores resource identifiers in association with resource data. Since the steps for setting a user parameter (step 21), executing an application (step 22), and reading a resource identifier (step 23) are similar to the steps described with reference to FIG. 4, description starts at an entry point S23, that is, after step 23 described with reference to FIG. 4.

Referring to FIG. 5b, in step S3b1, the lookup component 183 calls a dictionary function for obtaining one of a plurality of lookup objects corresponding to the user parameter, wherein the retrieved lookup object links the resource identifier with the resource data dependent on the selected user parameter. The dictionary function thus selects at least one of a plurality of lookup objects in dependence on the selected user parameter.

The dictionary function may receive the selected user parameter, for example, from a session object or application object, and may accordingly select at least one of a plurality of lookup objects in correspondence to the selected user parameter. The lookup object may be loaded, for example, from a session object or an application object, into the environment of the application such that the lookup function may access the identified lookup object for obtaining resource data.

In step S3b2, the lookup component 183 performs the lookup operation using the resource identifier for obtaining the resource data, for example, for presentation to the user.

For example, when a resource identifier res_ID_IP and a user parameter “49” for the environment “Germany” are provided, the lookup object may contain information as shown in Table 3.

TABLE 3

| | |
|---|---|
| res_ID_IP | “Gewerblicher Rechtschutz” |

In case a user parameter “01” for the environment “United States” is selected, a lookup object may contain information as outlined in Table 4.

TABLE 4

| | |
|---|---|
| res_ID_IP | “Intellectual Property” |

The above-described lookup objects contain further resource identifiers and resource data.

Further, for each language identifier, a plurality of lookup objects may be provided, for example, depending on applications and requirements.

The embodiment described with reference to FIG. 5b provides a two-step operation to retrieve the required resource data, by first identifying a lookup object corresponding to the selected user identifier, e.g. selected language, and then by retrieving the resource data using the resource identifier. Accordingly, an application independent of a user environment may be executed and localized information may be introduced into, for example, frames for presentation to a user.

Referring to FIG. 5c, that figure illustrates a flow chart of a process performed by the resource program in accordance with another embodiment consistent with methods, systems, and articles of manufacture consistent with the present invention. Similar to the embodiment described with reference to FIG. 5a, the embodiment depicted in FIG. 5c illustrates steps performed by the resource program for retrieving resource data for presentation to one or a plurality of users.

FIG. 5c illustrates an example wherein the lookup component 183 retrieves one of a plurality of lookup objects that correspond to selected user parameters. Thus, for each user parameter a lookup object is available that stores resource identifiers in association with resource data. Since the steps for setting a user parameter (step 21), executing an application (step 22), reading a resource identifier (step 23), and loading a lookup object (step 24) are similar to the steps described with reference to FIG. 4, description starts at an entry point S24, that is, after step 24 described with reference to FIG. 4.

In a step S3c1, the lookup component 183 executes the lookup operation based on a resource identifier in a lookup object, wherein the lookup object links the resource identifier with a plurality of user parameters and each of the plurality of user parameters with resource data dependent on the respective user parameter. The lookup component 183 can first locate the resource identifier in the lookup object and the selected user parameter, and thereby retrieve the resource data corresponding to the resource identifier and the selected user parameter.

Similar to the examples described with reference to FIGS. 5a and 5b, when a resource identifier res_ID_IP and user parameters “49” and “01” for the environments “Germany” and “United States” are provided, the lookup object may contain information as shown in Table 5.

TABLE 5

| | | |
|---|---|---|
| res_ID_IP | 49 | “Gewerblicher Rechtschutz” |
| | 01 | “Intellectual Property” |

The lookup object may contain a plurality of resource identifiers or resource functions as described with reference to FIG. 5a and 5b.

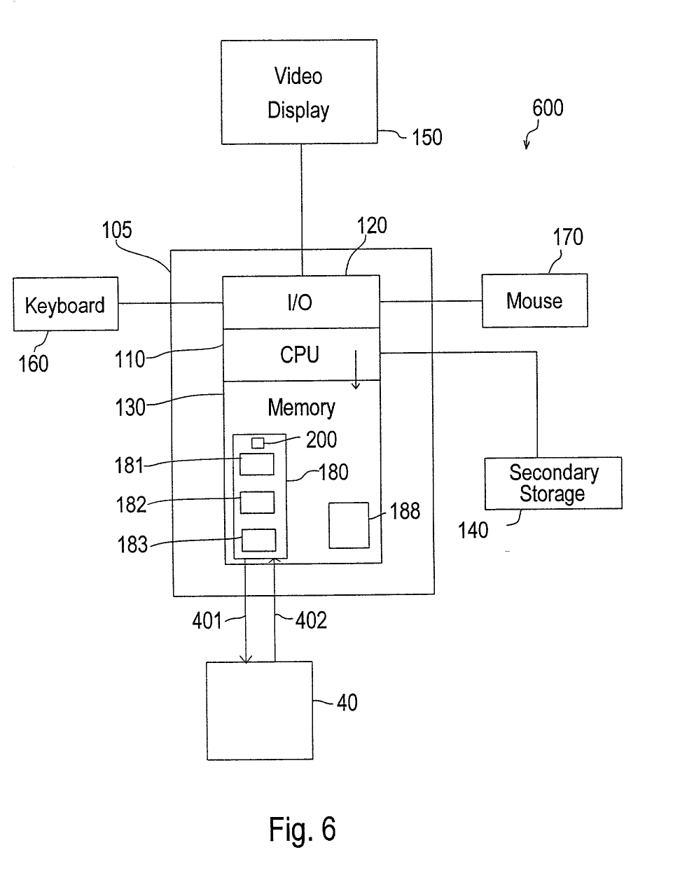

Referring to FIG. 6, that figure shows a block diagram of a data processing system 600 suitable for practicing methods and implementing systems consistent with the present invention. The data processing system 600 is configured in a manner similar to data processing system 100. Note, however, that (as explained in more detail below) the data processing system 600 comprises a client 40 communicating with the resource program 180. Even though only one client is shown, a plurality of clients at different locations (e.g., different countries or regions) may be provided.

The client 40 may be a data processing device operated by a user and may communicate with the resource program 180 via a communication network or dedicated communication link, including wireless transmissions, as indicated by arrows 401 and 402. The client 40 may control an application executed at the resource program by transmitting instructions or requests to the resource program as indicated by arrow 401. For example, the client 40 may request a particular web page.

Further, the client 40 may transmit a selected user parameter to the resource program, for example, upon request by the resource program, or may transmit the user parameter in association with a URL (Uniform Resource Locator) transmitted in a request to the resource program. Thus, the client 40 may comprise components for selecting the user parameter at the client (e.g., by user input), and for transmitting the user parameter to the data processing device 600.

The resource program may store the user parameter transmitted from the client in an object such that the user parameter is readily available in case an application independent of the user parameter is executed by the resource program and “localized” resource data need to be presented to the user.

The resource program may maintain a plurality of user parameters in the object, preferably in association with client identifiers, in order to be able to serve a large number of clients.

The resource program, upon retrieving resource data may transmit the resource data to the client 40 as indicated by an arrow 402.

Apart from the above-described features, the data processing system 600 shown in FIG. 6 is similar to the data processing system 100 shown in FIG. 1.

All communications in the illustrative data processing system 600 may be executed via communication networks, via dedicated communication links, including wireless transmission, or other methods or systems.

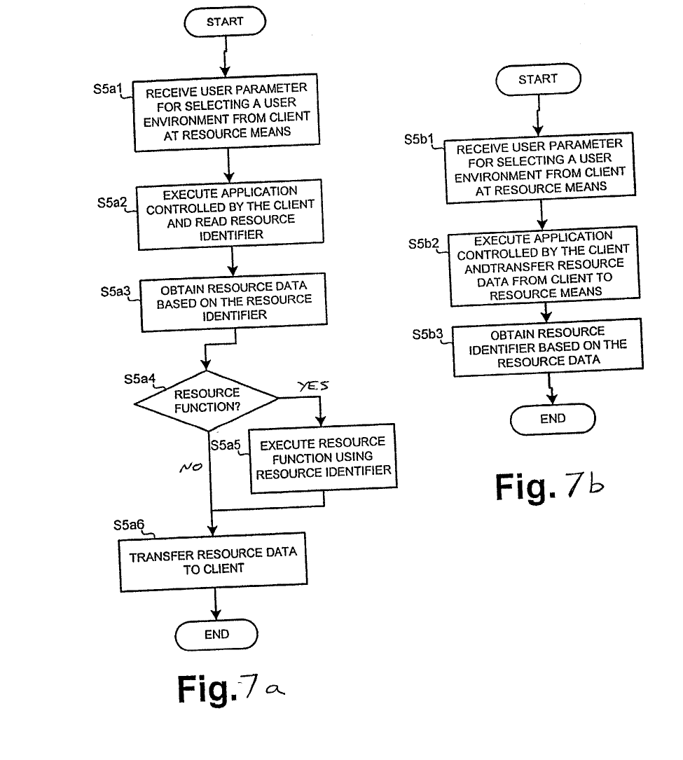

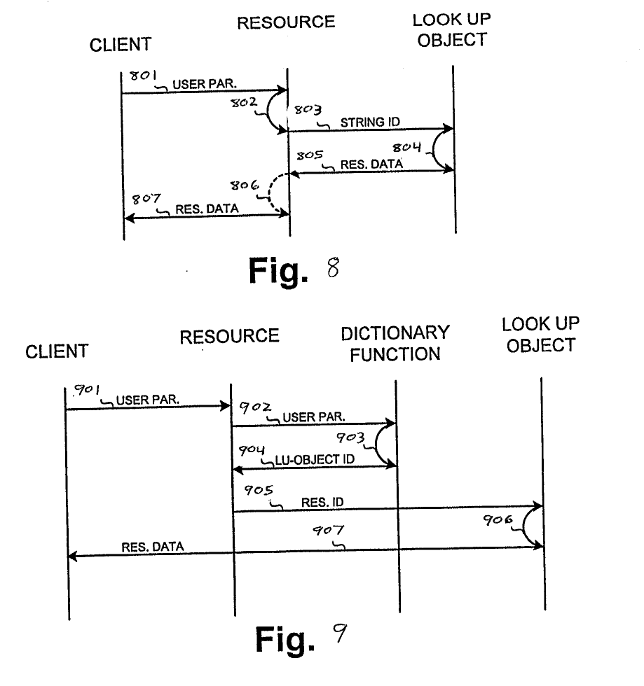

Referring to FIG. 7a, that figure illustrates a flow chart of a process performed by the resource program in accordance with another embodiment consistent with methods, systems, and articles of manufacture consistent with the present invention. The sequence of steps depicted in FIG. 7a may be executed by the data processing system 600 shown in FIG. 6, however, FIG. 7a is not limited thereto. FIG. 7a particularly outlines steps for presenting “localized” resource data to a user in accordance with a selected user environment. The following description of the process of FIG. 7a illustratively refers to the data processing system 600 of FIG. 6.

In step S5a1, the user parameter component 181 receives a user parameter, for example, from a session object or application object, for setting a user environment from the client 40.

In step S5a2, the application program 182 executes an application that is controlled by the client 40. Further, the application program 182 reads a resource identifier independent of the user parameter in connection with the application.

In step S5a3, the lookup component 183 retrieves resource data based on the resource identifier from the lookup table 188 in a manner similar to the above-described embodiments.

In step S5a4, the lookup component 183 determines whether the retrieved resource data correspond to a resource function. If the lookup component 183 determines that the resource data corresponds to the resource function in step S5a4, then the lookup component 183 executes the resource function in dependence on the resource identifier (step S5a5). The resource function defines, for example, a format conversion of date, time, currency, or floating point number, as described above. Then the lookup component 183 transmits the resource data directly to the client (step S5a6).

If the lookup component 183 determines that the resource data does not corresponds to the resource function in step S5a4, then the lookup component 183 bypasses step S5a5 and transmits the resource data directly to the client (step S5a6).

The process illustrated in FIG. 7a provides a user with, for example, localized text information in a language that corresponds to the user parameter or with information in a format (e.g., floating point representation or date representation) that is familiar to the user.

Referring to FIG. 7b, that figure illustrates a flow chart of a process performed by the resource program in accordance with another embodiment consistent with methods, systems, and articles of manufacture consistent with the present invention. The sequence of steps depicted in FIG. 7b may be executed by the data processing system 600 shown in FIG. 6, however, FIG. 7b is not limited thereto. FIG. 7b particularly outlines steps for receiving resource data depending on a user parameter from a user (e.g. in a local language or format), and for converting the received resource data into a resource identifier independent of the user parameter. The following description of the process of FIG. 7b illustratively refers to the data processing system 600 of FIG. 6.

In step S5b1, the user parameter component 181 receives a user parameter for setting a user environment from the client 40. However, it is also possible that the user parameter is already stored in memory 130, for example, in an object.

In step S5b2, the application component 182 executes an application that is controlled by the client 40, and receives resource data dependent on the user parameter from the client 40. For example, the client 40 could transmit a date in a local format to the resource program.

In step S5b3, the lookup component 183 retrieves a resource identifier based on the received resource data, the resource identifier being independent of the user parameter. The resource program may use the resource identifier for internal processing. The resource program may then output a processing result to the user.

The process depicted in FIG. 7b may use resource functions as outlined with respect to previous embodiments and facilitate converting information provided by a user in a local format or language into a representation which is independent of the locality or language of the user.

Referring to FIG. 8, that figure illustrates a time sequence of processing steps a performed by the resource program in accordance with another embodiment consistent with methods, systems, and articles of manufacture consistent with the present invention. FIG. 8 outlines steps for providing resource data (i.e., localized data to a client), similar to the embodiment described above with reference to FIG. 5a. The sequence of processing steps may be executed by the data processing system 600 depicted in FIG. 6, however, FIG. 8 is not limited thereto. The following description of FIG. 8 illustratively refers to the data processing system 600 of FIG. 6.

FIG. 8 shows processing steps involving a client 40, resource program 180, a lookup object. Even though the lookup object may comprise a code section executed at the resource program, for illustration purposes, the lookup object is shown as a separate entity.

In step 804, the resource program receives a user parameter from the client. The user parameter specifies a user environment, such as a location or a preferred language. The user parameter is stored by the resource program in memory 130, for example, in a list of user parameters associated with a client identifier.

In step 802, the application component 182 of the resource program executes an application independent of the user parameter, and, in connection therewith, reads a resource identifier identifying a resource independent of the user parameter. Further, in step 802, the lookup component 183 combines the user parameter with the resource identifier to obtain a string identifier, for example, discussed above with reference to FIG. 5a.

In step 803, the lookup component 183 transmits the string identifier from the resource program to the lookup object.

In step 804, the lookup component 183 retrieves corresponding resource data based on the transmitted string identifier. An example of this step is described above with reference to FIG. 5a.

In step 805, the lookup component 183 transmits the resource data to the client for local display at the client. The resource data, as outlined with respect to previous embodiments, may represent expressions in a language corresponding to the selected user parameter.

Further, in case the resource data are associated with a resource function, as outlined with respect to previous embodiments, for example in case a current date or time was retrieved and is to be presented to the user in a particular format, corresponding operations may be executed by the resource program, as indicated by step 806.

In step 807, the lookup component 183 provides the resource data to the client in a format corresponding to the user parameter.

The lookup component 183 may also transmit the resource data directly from the lookup object to the client in step 805.

The embodiment described with reference to FIG. 8 provides a user with “localized information”, such as expressions in a particular language corresponding to the user parameter or representations of for example date or time, in a format corresponding to the user parameter.

Referring to FIG. 9, that figure illustrates a time sequence of processing steps a performed by the resource program in accordance with another embodiment consistent with methods, systems, and articles of manufacture consistent with the present invention. FIG. 9 outlines steps for providing a client with resource data in correspondence to a selected user parameter. The sequence of processing steps may be executed by the data processing system 600 depicted in FIG. 6, however, FIG. 9 is not limited thereto. The following description of FIG. 9 illustratively refers to the data processing system 600 of FIG. 6.

FIG. 9 shows processing steps involving a client, the resource program, a dictionary function, and a lookup object. Even though the dictionary function and the lookup object may comprise code sections executed by the resource program, the dictionary function and the lookup object are shown as separate entities.

In step 901, the user parameter component 181 of the resource program receives a user parameter that was selected by the client in correspondence to the client, for example, for storage in an object containing client identifiers in association with user parameters.

In step 902, the resource program transmits the user parameter to the dictionary function.

In step 903, the dictionary function selects one of a plurality of lookup objects in correspondence to the transmitted user parameter. An example of this step is described in more detail above with reference to FIG. 5b.

In step 904, the dictionary function returns, to the resource program, a lookup object identifier that identifies the detected lookup object corresponding to the user parameter.

In step 905, the resource program transmits a read resource identifier independent of a user parameter to the detected lookup object using the received lookup object identifier.

In step 906, the lookup object retrieves the corresponding resource data.

In step 907, the lookup object transmits the resource data to the client.

In case the resource data correspond to a resource function, steps similar to steps 805, 806 and 807 of FIG. 8 may be performed.

The embodiment of FIG. 9 provides a two-step operation of first identifying an appropriate lookup object corresponding to the user parameter and then retrieving the desired resource data based on the resource identifier from the detected lookup object.

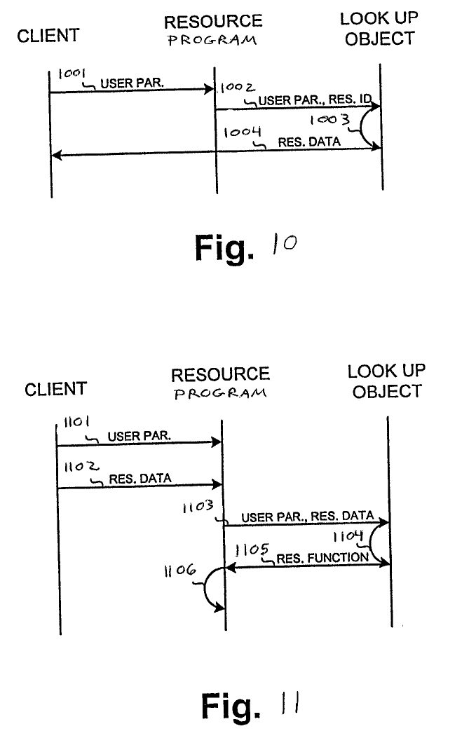

Referring to FIG. 10, that figure illustrates a time sequence of processing steps performed by the resource program in accordance with another embodiment consistent with methods, systems, and articles of manufacture consistent with the present invention. FIG. 10 outlines steps for providing a client with resource data in correspondence to a selected user parameter. FIG. 10 illustrates an embodiment similar to the embodiment described with reference to FIG. 5c, and shows steps involving a client, the resource program and a lookup object. The sequence of processing steps may be executed by the data processing system 600 depicted in FIG. 6, however, FIG. 10 is not limited thereto. The following description of FIG. 10 illustratively refers to the data processing system 600 of FIG. 6.

In step 1001, the user parameter component 181 of the resource program receives a user parameter from the client.

In step 1002, the application component 182 of the resource program reads a resource identifier independent of the user parameter in accordance with the execution of an application and transmits the user parameter and the resource identifier to the lookup object.

In step 1003, the lookup object retrieves resource data corresponding to the user parameter and the resource identifier.

In step 1004, the lookup object transmits the retrieved resource data to the client.

Referring to FIG. 11, that figure illustrates a time sequence of processing steps a performed by the resource program in accordance with another embodiment consistent with methods, systems, and articles of manufacture consistent with the present invention. FIG. 11 outlines steps for providing a client with resource data in correspondence to a selected user parameter. FIG. 11 shows steps involving a client, the resource program and a lookup object. The sequence of processing steps may be executed by the data processing system 600 depicted in FIG. 6, however, FIG. 11 is not limited thereto. The following description of FIG. 11 illustratively refers to the data processing system 600 of FIG. 6.

In step 1101, the user parameter component 181 of the resource program receives a user parameter from the client.

In step 1102, the resource program receives resource data (e.g., data in a local format or language) from the client. The resource data may, for example, be a floating point number in a local format.

In step 1103, the resource program transmits the user parameter and the resource data to the lookup object.

In step 1104, the lookup object determines a resource identifier (e.g., a resource function) to be applied to the resource data.

In step 1105, the lookup object transmits the resource identifier (or the resource function) to the resource program.

In step 1106, the resource program then converts the received resource data (e.g., a floating point number) in a “local” format into a format internal to the resource means, and independent of the user parameter. The resource program can perform the conversion by using a look up object.

The steps outlined with reference to FIG. 11 provide conversion of a user input dependent on a user parameter, i.e. a “localized” input, into a form which is independent of the user parameter and which may be used by the resource program for further processing.

As described in the above embodiments, for example, when writing web applications or web pages which may be used by users from different countries or localities, the applications may be developed independently of the intended users and may then be “localized” for the different countries or localities.

Thus, in an environment of, for example, Microsoft® Active Server® Pages and the Visual Basic® Scripting language, a set of functions can be used to add “internationalization support”. Instead of copying active server pages and then translating these copied pages into different formats or languages, the functions can convert a generic active server page (e.g., a server page independent of user parameters or user environments) into a representation for display at a user which is dependent on a selected user parameter or environment.

The above-described functions provide support for localized text resources, provide for conversion of locally different user inputs like date and time into internal objects and for storage of the data in these objects, and further provide conversion of these objects into a localized format for a user.

Prior to using the functions, the user parameter must be defined. The user parameter can be defined by offering the user a web page with a language selection. This information can be stored in a session object, or it may also passed to following pages in a URL.

When localized text resources are provided, after the user has selected a language by selecting a user parameter, the application loads the text resources required for the application in a lookup object. The lookup object may map a resource description, i.e. the resource identifier, to the actual resource text, i.e. the resource data. The lookup object may be stored in an application object (or session object) and may be identified by a language identifier.

After initializing the lookup object, an active server page application may use the lookup function taking a resource identifier as a parameter and returning a resource data depending on the user parameter. Further, a function may check whether a dictionary exists for the selected user parameter and may retrieve text from the lookup object.

When there is a non-existing resource identifier, an error message may be generated.

When locally different user input (such as date, time, or a floating point number) is to be converted into an internal format, such as to a Visual Basic® Script object, the user input may be converted from a locally dependent format to a locally independent Visual Basic® Script object using a resource function, as described above.

When a user is to be provided with a localized representation of, for example, date, time, or floating point numbers, the internal format may be converted into the local format using a resource function, also as described above.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed:

1. A method in a data processing system for providing resources adapted to at least one of a plurality of user environments, the method comprising the steps of:
initiating execution of a program, the program having a session object and a resource identifier that is associated with a plurality of resource data stored in the session object; and
while the program is executing,
determining from the session object which of the plurality of user environments the program is executing in; and
identifying which of the resource data is suitable for the determined user environment by using both the resource identifier and the determined user environment.

2. The method of claim 1, wherein the determined user environment identifies a location of a user of the program.

3. The method of claim 1, wherein the determined user environment identifies a language of a user of the program.

4. The method of claim 1, wherein the program has a plurality of resource identifiers; and the method further comprising the steps of:
while the program is executing,
receiving a received resource data; and
identifying which of the resource identifiers is suitable for the determined user environment by using both the received resource data and the determined user environment.

5. The method of claim 1, wherein the step of identifying which of the resource data is suitable comprises:
loading a lookup object for linking the resource identifier with the resource data suitable for the determined user environment; and
obtaining the suitable resource data from the lookup object by using the resource identifier and the determined user environment.

6. The method of claim 5, wherein a number of users are using the data processing system; and wherein at least one lookup object is loaded for each user.

7. The method of claim 5, wherein a number of users are using the data processing system; and wherein at least one lookup object is loaded for a plurality of users.

8. The method of claim 5, wherein the step of obtaining the suitable resource data comprises:
generating a string identifier comprising the resource identifier and the user environment; and
obtaining the suitable resource data using the generated string identifier, wherein the lookup object includes a link between the string identifier and the suitable resource data.

9. The method of claim 5, wherein the step of obtaining the suitable resource data comprises:
invoking a dictionary function to obtain one of a plurality of lookup objects corresponding to the determined user environment and that link the resource identifier with the suitable resource data.

10. A method in a data processing system for providing resources adapted to at least one of a plurality of user environments, the method comprising the steps of:
initiating execution of the program, the program having a session object and a resource identifier that is associated with a plurality of resource data stored in the session object; and
while the program is executing,
determining from the session object which of the plurality of user environments the program is executing in;
loading a lookup object for linking the resource identifier with a resource data suitable for the determined user environment; and
obtaining the suitable resource data from the lookup object by using the resource identifier and the determined user environment.

11. A computer-readable medium containing instructions that cause a data processing system to perform a method for providing resources adapted to at least one of a plurality of user environments, the method comprising the steps of:
initiating execution of a program, the program having a session object and a resource identifier that is associated with a plurality of resource data stored in the session object; and
while the program is executing,
determining from the session object which of the plurality of user environments the program is executing in; and
identifying which of the resource data is suitable for the determined user environment by using both the resource identifier and the determined user environment.

12. The computer-readable medium of claim 11, wherein the determined user environment identifies a location of a user of the program.

13. The computer-readable medium of claim 11, wherein the determined user environment identifies a language of a user of the program.

14. The computer-readable medium of claim 11, wherein the program has a plurality of resource identifiers; and the method further comprising the steps of:
while the program is executing,
receiving a received resource data; and
identifying which of the resource identifiers is suitable for the determined user environment by using both the received resource data and the determined user environment.

15. The computer-readable medium of claim 11, wherein the step of identifying which of the resource data is suitable comprises:
loading a lookup object for linking the resource identifier with the resource data suitable for the determined user environment; and
obtaining the suitable resource data from the lookup object by using the resource identifier and the determined user environment.

16. The computer-readable medium of claim 15, wherein a number of users are using the data processing system; and wherein at least one lookup object is loaded for each user.

17. The computer-readable medium of claim 15, wherein a number of users are using the data processing system; and wherein at least one lookup object is loaded for a plurality of users.

18. The computer-readable medium of claim 15, wherein the step of obtaining the suitable resource data comprises:
generating a string identifier comprising the resource identifier and the user environment; and
obtaining the suitable resource data using the generated string identifier, wherein the lookup object includes a link between the string identifier and the suitable resource data.

19. The computer-readable medium of claim 15, wherein the step of obtaining the suitable resource data comprises:
invoking a dictionary function to obtain one of a plurality of lookup objects corresponding to the determined user environment and that link the resource identifier with the suitable resource data.

20. A computer-readable medium containing instructions that cause a data processing system to perform a method for providing resources adapted to at least one of a plurality of user environments, the method comprising the steps of:
initiating execution of a program, the program having a session object and a resource identifier that is associated with a plurality of resource data stored in the session object; and
while the program is executing,
determining from the session object which of the plurality of user environments the program is executing in;
loading a lookup object for linking the resource identifier with a resource data suitable for the determined user environment; and
obtaining the suitable resource data from the lookup object by using the resource identifier and the determined user environment.

21. A data processing system for providing resources adapted to at least one of a plurality of user environments, the data processing system comprising:
a memory comprising a program having a session object and a resource identifier that is associated with a plurality of resource data stored in the session object, the program determining from the session object which of a plurality of user environments the program is executing in, and identifying which of the resource data is suitable for the determined user environment by using both the resource identifier and the determined user environment; and
a processing unit that runs the program.

22. The data processing system of claim 21, wherein the program has a plurality of resource identifiers; and wherein the program identifies which of the resource identifiers is suitable for the determined user environment by using both a received resource data and the determined user environment.

23. The data processing system of claim 21, wherein the resource data comprise a string of at least one character.

24. The data processing system of claim 21, wherein the resource data comprise a resource function including rules for character representation.

25. The data processing system of claim 21, wherein the determined user environment identifies a location of a user of the program.

26. The data processing system of claim 21, wherein the determined user environment identifies a language of a user of the program.

27. The data processing system of claim 21, wherein the program determines the suitable resource data by loading a lookup object for linking the resource identifier with the resource data suitable for the determined user environment, and obtaining the suitable resource data from the lookup object by using the resource identifier and the determined user environment.

28. The data processing system of claim 21, wherein the program comprises:
a user parameter component for determining the user environment the program is executing in;
an application component for initiating execution of the program; and
a lookup component for identifying the suitable resource data.

29. The data processing system of claim 28, wherein the lookup component generates a string identifier comprising the resource identifier and the user environment, and generates the suitable resource data using the generated string identifier.

30. The data processing system of claim 28, wherein the lookup component invokes a dictionary function to obtain one of a plurality of lookup objects corresponding to the determined user environment and that link the resource identifier with the suitable resource data.

31. A data processing system for providing resources adapted to at least one of a plurality of user environments, the data processing system comprising:
means for initiating execution of a program, the program having a session object and a resource identifier that is associated with a plurality of resource data stored in the session object; and
means for, while the program is executing,
determining from the session object which of the plurality of user environments the program is executing in; and
identifying which of the resource data is suitable for the determined user environment by using both the resource identifier and the determined user environment.

32. A computer-readable memory device encoded with a data structure with entries that are accessed by a program which is encoded on the memory device and which is run by a processor in a system, each entry comprising:
a first storage area that stores a resource identifier; and
a plurality of second storage areas that each store one of a plurality of resource data corresponding to the resource identifier, each resource data associated with at least one user environment of a session object, wherein the program determines a suitable resource data to be used by using the resource identifier and an indication of a current user environment in which the program is running.

33. A method in a data processing system for providing resources adapted to at least one of a plurality of user environments, the method comprising the steps of:
initiating execution of a program, the program having an application object and a resource identifier that is associated with a plurality of resource data stored in the application object; and
while the program is executing,
determining from the application object which of the plurality of user environments the program is executing in; and
identifying which of the resource data is suitable for the determined user environment by using both the resource identifier and the determined user environment.

34. The method of claim 33, wherein the determined user environment identifies a location of a user of the program.

35. The method of claim 33 wherein the determined user environment identifies a language of a user of the program.

36. The method of claim 33, wherein the program has a plurality of resource identifiers; and the method further comprising the steps of:
while the program is executing,
receiving a received resource data; and
identifying which of the resource identifiers is suitable for the determined user environment by using both the received resource data and the determined user environment.

37. The method of claim 33, wherein the step of identifying which of the resource data is suitable comprises:
loading a lookup object for linking the resource identifier with the resource data suitable for the determined user environment; and
obtaining the suitable resource data from the lookup object by using the resource identifier and the determined user environment.

38. The method of claim 37, wherein a number of users are using the data processing system; and wherein at least one lookup object is loaded for each user.

39. The method of claim 37, wherein a number of users are using the data processing system; and wherein at least one lookup object is loaded for a plurality of users.

40. The method of claim 37, wherein the step of obtaining the suitable resource data comprises:
generating a string identifier comprising the resource identifier and the user environment; and
obtaining the suitable resource data using the generated string identifier, wherein the lookup object includes a link between the string identifier and the suitable resource data.

41. The method of claim 37, wherein the step of obtaining the suitable resource data comprises:
invoking a dictionary function to obtain one of a plurality of lookup objects corresponding to the determined user environment and that link the resource identifier with the suitable resource data.

42. A method in a data processing system for providing resources adapted to at least one of a plurality of user environments, the method comprising the steps of:
initiating execution of the program, the program having an application object and a resource identifier that is associated with a plurality of resource data stored in the application object; and
while the program is executing,
determining from the application object which of the plurality of user environments the program is executing in;
loading a lookup object for linking the resource identifier with a resource data suitable for the determined user environment; and
obtaining the suitable resource data from the lookup object by using the resource identifier and the determined user environment.

43. A computer-readable medium containing instructions that cause a data processing system to perform a method for providing resources adapted to at least one of a plurality of user environments, the method comprising the steps of:
initiating execution of a program, the program having an application object and a resource identifier that is associated with a plurality of resource data stored in the application object; and
while the program is executing,
determining from the application object which of the plurality of user environments the program is executing in; and
identifying which of the resource data is suitable for the determined user environment by using both the resource identifier and the determined user environment.

44. The computer-readable medium of claim 43, wherein the determined user environment identifies a location of a user of the program.

45. The computer-readable medium of claim 43, wherein the determined user environment identifies a language of a user of the program.

46. The computer-readable medium of claim 43, wherein the program has a plurality of resource identifiers; and the method further comprising the steps of:
while the program is executing,
receiving a received resource data; and
identifying which of the resource identifiers is suitable for the determined user environment by using both the received resource data and the determined user environment.

47. The computer-readable medium of claim 43, wherein the step of identifying which of the resource data is suitable comprises:
loading a lookup object for linking the resource identifier with the resource data suitable for the determined user environment; and
obtaining the suitable resource data from the lookup object by using the resource identifier and the determined user environment.

48. The computer-readable medium of claim 47, wherein a number of users are using the data processing system; and wherein at least one lookup object is loaded for each user.

49. The computer-readable medium of claim 47, wherein a number of users are using the data processing system; and wherein at least one lookup object is loaded for a plurality of users.

50. The computer-readable medium of claim 47, wherein the step of obtaining the suitable resource data comprises:
generating a string identifier comprising the resource identifier and the user environment; and
obtaining the suitable resource data using the generated string identifier, wherein the lookup object includes a link between the string identifier and the suitable resource data.

51. The computer-readable medium of claim 47, wherein the step of obtaining the suitable resource data comprises:
invoking a dictionary function to obtain one of a plurality of lookup objects corresponding to the determined user environment and that link the resource identifier with the suitable resource data.

52. A computer-readable medium containing instructions that cause a data processing system to perform a method for providing resources adapted to at least one of a plurality of user environments, the method comprising the steps of:
initiating execution of a program, the program having an application object and a resource identifier that is associated with a plurality of resource data stored in the application object; and
while the program is executing,
determining from the application object which of the plurality of user environments the program is executing in;
loading a lookup object for linking the resource identifier with a resource data suitable for the determined user environment; and
obtaining the suitable resource data from the lookup object by using the resource identifier and the determined user environment.

53. A data processing system for providing resources adapted to at least one of a plurality of user environments, the data processing system comprising:
a memory comprising a program having a session object and a resource identifier that is associated with a plurality of resource data stored in the session object, the program determining from the session object which of a plurality of user environments the program is executing in, and identifying which of the resource data is suitable for the determined user environment by using both the resource identifier and the determined user environment; and
a processing unit that runs the program.

54. The data processing system of claim 53, wherein the program has a plurality of resource identifiers; and wherein the program identifies which of the resource identifiers is suitable for the determined user environment by using both a received resource data and the determined user environment.

55. The data processing system of claim 53, wherein the resource data comprise a string of at least one character.

56. The data processing system of claim 53, wherein the resource data comprise a resource function including rules for character representation.

57. The data processing system of claim 53, wherein the determined user environment identifies a location of a user of the program.

58. The data processing system of claim 53, wherein the determined user environment identifies a language of a user of the program.

59. The data processing system of claim 53, wherein the program determines the suitable resource data by loading a lookup object for linking the resource identifier with the resource data suitable for the determined user environment, and obtaining the suitable resource data from the lookup object by using the resource identifier and the determined user environment.

60. The data processing system of claim 53, wherein the program comprises:
a user parameter component for determining the user environment the program is executing in;
an application component for initiating execution of the program; and
a lookup component for identifying the suitable resource data.

61. The data processing system of claim 60, wherein the lookup component generates a string identifier comprising the resource identifier and the user environment, and generates the suitable resource data using the generated string identifier.

62. The data processing system of claim 60, wherein the lookup component invokes a dictionary function to obtain one of a plurality of lookup objects corresponding to the determined user environment and that link the resource identifier with the suitable resource data.

63. A data processing system for providing resources adapted to at least one of a plurality of user environments, the data processing system comprising:
means for initiating execution of a program, the program having an application object and a resource identifier that is associated with a plurality of resource data stored in the application object; and
means for, while the program is executing,
determining from the application object which of the plurality of user environments the program is executing in; and
identifying which of the resource data is suitable for the determined user environment by using both the resource identifier and the determined user environment.

64. A computer-readable memory device encoded with a data structure with entries that are accessed by a program which is encoded on the memory device and which is run by a processor in a system, each entry comprising:
a first storage area that stores a resource identifier; and
a plurality of second storage areas that each store one of a plurality of resource data corresponding to the resource identifier, each resource data associated with at least one user environment of an application object, wherein the program determines a suitable resource data to be used by using the resource identifier and an indication of a current user environment in which the program is running.
